(19) United States
(12) Patent Application Publication
(10) Pub. No.: US 2023/0160705 A1
(43) Pub. Date: May 25, 2023

(54) METHOD, APPARATUS, AND SYSTEM FOR LINEARIZING A NETWORK OF FEATURES FOR MACHINE LEARNING TASKS

(71) Applicant: HERE Global B.V., Eindhoven (NL)

(72) Inventors: Bo XU, Lisle, IL (US); Rohit GUPTA, Steinhausen (CH); David JONIETZ, Zürich (CH); Ali SOLEYMANI, Zürich (CH)

(21) Appl. No.: 17/533,877

(22) Filed: Nov. 23, 2021

(51) Int. Cl. G01C 21/34; G06N 5/04; G06K 9/62

(52) U.S. Cl. CPC G01C 21/3461; G06N 5/04; G06K 9/6256; G06K 9/6277

(57) ABSTRACT

An approach is provided for linearizing a network of features for machine learning tasks. The approach involves, for instance, receiving a graph representation of a network of a plurality of features. For example, a plurality of vertices of the graph representation, an edge connecting two vertices of the plurality of vertices, or a combination thereof respectively represents the plurality of features. The approach also involves determining a linear order of the plurality of features based on a selected criterion. The approach further involves generating a vector representation of the plurality of features based on the linear order. The approach further involves using the vector representation as an input, an output, or a combination thereof of a machine learning model.

### BACKGROUND

Service providers are increasingly using machine learning models to make inferences based on a network of features (e.g., a road network made of multiple connected road segments, a social network of multiple connected users, etc.). For many machine learning applications, these networks of features can be input to machine learning models (e.g., convolutional neural networks (CNNs)) to make predictions, classifications, etc. However, such input data often are sparse and contain many empty pixels or bins of data. As a result, service providers face significant technical challenges with respect to ensuring that machine learning models with limited receptive fields for processing input data (such as CNNs) do not miss feature relationships or correlations that may extend beyond the receptive fields.

### SOME EXAMPLE EMBODIMENTS

Therefore, there is a need for linearizing a network of features for machine learning tasks or equivalent applications such that potentially distant or remote feature correlations are preserved.

According to one embodiment, a method comprises receiving a graph representation of a network of a plurality of features. By way of example, a plurality of vertices of the graph representation, an edge connecting two vertices of the plurality of vertices, or a combination thereof respectively represents the plurality of features. The method also comprises determining a linear order of the plurality of features based on a selected criterion. In one embodiment, determining a linear order can include at least one of: (1) determining a path that passes each edge of the graph representation exactly once; (2) determining a feature correlation among the plurality of features based on a designated property of the plurality of features; or (3) using a trained machine learning model. The method further comprises generating a vector representation of the plurality of features based on the linear order. The method further comprises providing the vector representation as an output, or using the vector representation as an input, an output, or a combination thereof of a machine learning model.

According to another embodiment, an apparatus comprises at least one processor, and at least one memory including computer program code for one or more computer programs, the at least one memory and the computer program code configured to, with the at least one processor, cause, at least in part, the apparatus to receive a graph representation of a network of a plurality of features. By way of example, a plurality of vertices of the graph representation, an edge connecting two vertices of the plurality of vertices, or a combination thereof respectively represents the plurality of features. The apparatus is also caused to determine a linear order of the plurality of features based on a selected criterion. In one embodiment, determining a linear order can include at least one of: (1) determining a path that passes each edge of the graph representation exactly once; (2) determining a feature correlation among the plurality of features based on a designated property of the plurality of features; or (3) using a trained machine learning model. The apparatus is further caused to generate a vector representation of the plurality of features based on the linear order. The apparatus is further caused to provide the vector representation as an output, or to use the vector representation as an input, an output, or a combination thereof of a machine learning model.

According to another embodiment, a non-transitory computer-readable storage medium carries one or more sequences of one or more instructions which, when executed by one or more processors, cause, at least in part, an apparatus to receive a graph representation of a network of a plurality of features. By way of example, a plurality of vertices of the graph representation, an edge connecting two vertices of the plurality of vertices, or a combination thereof respectively represents the plurality of features. The apparatus is also caused to determine a linear order of the plurality of features based on a selected criterion. In one embodiment, determining a linear order can include at least one of: (1) determining a path that passes each edge of the graph representation exactly once; (2) determining a feature correlation among the plurality of features based on a designated property of the plurality of features; or (3) using a trained machine learning model. The apparatus is further caused to generate a vector representation of the plurality of features based on the linear order. The apparatus is further caused to provide the vector representation as an output, or to use the vector representation as an input, an output, or a combination thereof of a machine learning model. Also, a computer program product may be provided. For example, a computer program product comprising instructions which, when the program is executed by a computer, cause the computer to carry out the steps described herein.

According to another embodiment, an apparatus comprises means for receiving a graph representation of a network of a plurality of features. By way of example, a plurality of vertices of the graph representation, an edge connecting two vertices of the plurality of vertices, or a combination thereof respectively represents the plurality of features. The method also comprises determining a linear order of the plurality of features based on a selected criterion. In one embodiment, determining a linear order can include at least one of: (1) determining a path that passes each edge of the graph representation exactly once; (2) determining a feature correlation among the plurality of features based on a designated property of the plurality of features; or (3) using a trained machine learning model. The method further comprises generating a vector representation of the plurality of features based on the linear order. The method further comprises providing the vector representation as an output, or using the vector representation as an input, an output, or a combination thereof of a machine learning model.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one method/process or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of linearizing a network of features for machine learning tasks, according to one embodiment;

FIG. 2 is a diagram illustrating an example of a time-space diagram for traffic data, according to one embodiment;

FIG. 3 is a diagram of components of a mapping platform capable of linearizing a network of features for machine learning tasks, according to one embodiment;

FIG. 4 is a flowchart of a process for a network of features for machine learning tasks or equivalent applications, according to one embodiment;

FIG. 5 is a diagram illustrating an example graph that has a Eulerian path, according to one embodiment;

FIG. 6 is diagram illustrating an example graph with equal indegree and outdegree, according to one embodiment;

FIG. 7 is a diagram illustrating an example graph that does not have a Eulerian path, according to one embodiment

FIG. 8 is a diagram illustrating an example graph with added artificial arcs, according to one embodiment,

FIG. 9 is a diagram illustrating an example neural network trained to determine a linear order of features, according to one embodiment;

FIG. 10 is a diagram of a geographic database, according to one embodiment;

FIG. 11 is a diagram of hardware that can be used to implement an embodiment of the processes described herein;

FIG. 12 is a diagram of a chip set that can be used to implement an embodiment of the processes described herein; and

FIG. 13 is a diagram of a terminal that can be used to implement an embodiment of the processes described herein.

### DESCRIPTION OF SOME EMBODIMENTS

Examples of a method, apparatus, and computer program for linearizing a network of features for machine learning tasks are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

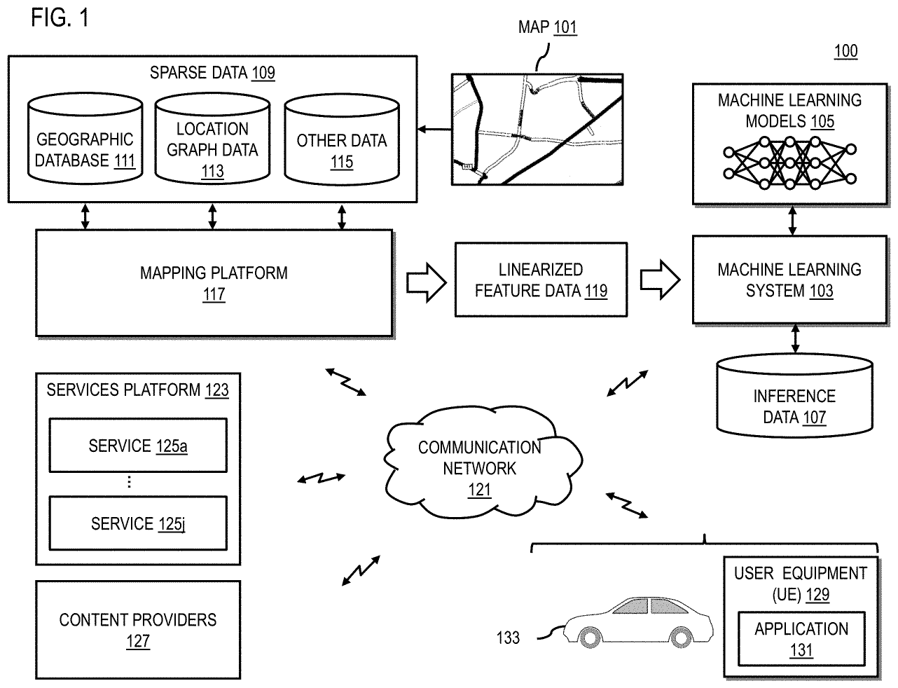

FIG. 1 is a diagram of a system capable of linearizing a network of features for machine learning tasks, according to one embodiment. The various example embodiments described herein relate to representing a network of features (e.g., roads, railways, rivers, pipelines, social connections etc.) as a single sequence of features. The single sequence facilitates estimating/predicting feature measures (e.g., traffic speed on roads, water flow in rivers, etc.) using machine learning (e.g., Convolutional Neural Networks (CNNs) and/or any other equivalent machine learning model) and can be used for specific routing applications, or visualizations of attributes of networks of features.

In one embodiment, a network is modeled as a directed graph G<V, E> wherein V is a set of vertices and E is a set of ordered pairs of vertices, called arcs. For an arc (u, v) (e.g., also referred to herein as “edges”), u and v are called the start node and the end node of the arc/edge, respectively. By way of example, for a network of features that is a road network (e.g., map 101), a vertex may correspond to an intersection, and an arc may correspond to a road segment starting at one intersection and ending at an adjacent intersection. A path is a sequence of arcs such that the end node of each arc in the sequence is the same as the start node of the next arc in the sequence.

Although the various embodiments described herein are applicable to various kinds of networks (e.g., river networks, social networks, etc.), for illustration and not as a limitation, road networks and traffic flows are used as a running example in the discussion below.

Historically, machine learning (ML) has been employed to estimate/predict traffic conditions in a transportation network. Depending on the exact task, a ML system 103 (e.g., comprising one or more machine learning models 105) may be provided with a representation of the past and/or current traffic state (e.g., average speed, volume) on each road segment of the network as input, which is then used to predict the current and/or future traffic state for each road segment (e.g., inference data 107). In one embodiment, the various embodiments described herein relate to linearizing a network of features (e.g., sparse data 109) to generate a potential data format (e.g., a one-dimensional vector representation of the features) for both input and output of machine learning tasks in similar scenarios as described above.

In one embodiment, sparse data 109 can include, but is not limited to: (1) a geographic database 111 storing a digital map data representing a geographic region (e.g., a road network within the region); (2) location graph data 113 storing a location-based knowledge graph (KG) of location entities and their relationships such as places/points of interest (POIs) and the relationship between places/POIs; and/or (3) any other data 115 (e.g., social networking data) that can be grouped or clustered into a graph representation (e.g., a directed graph).

In general, traffic is a highly spatially correlated phenomenon, meaning that road segments which are close to each other (in terms of their Euclidean distance and/or the network/graph topology) have a relatively higher probability of showing similar traffic states. In similar applications, CNNs are often used to capture such spatial correlations present in input data (typically in image-like data types). Due to their inherent functioning, however, an individual convolutional layer is only capable of capturing spatial correlations in the immediate spatial neighborhood of certain input values (e.g., pixel values in an image). In order to detect and utilize patterns which involve more distant sets of values, CNNs typically consist of multiple stacked convolutional layers (which however increases computational cost as well as the risk of overfitting to the training data).

An often used tool for capturing spatial correlations in graph networks are Graph Neural Networks (GNN) and in particular Graph Convolutional Neural Networks (GCNN). Rather than applying trainable filters to the spatial neighborhood of each pixel of an input image as in the case of CNN, GCNN perform similar operations on the nodes or edges of a graph, thereby defining their respective neighborhoods based on the topology of the graph. Comparable to the stacked layers in traditional CNNs, multiple steps of processing are needed in GCNN in order to capture longer distance correlations beyond the immediate neighborhood of a node or edge. Also, the message passing mechanism between nodes and/or edges is entirely determined by the graph topology, thereby not taking into account any correlation patterns of observed phenomena (e.g., actual traffic flows) on the network. A general disadvantage of GCNN compared to CNN, however, is their relatively higher complexity and computational cost.

To address the technical challenges associated with the disadvantages discussed above, the system 100 introduces a capability to process a network of features represented as a graph (e.g., sparse data 109) using, for instance, a mapping platform 117, into a format (e.g., linearized feature data 119) which can be processed by one-dimensional (1D), two-dimensional (2D), or three-dimensional (3D) convolutional operations in a CNN (e.g., ML models 105). In one embodiment, a 1D vector format or representation is used to represent the simplest and computationally cheapest option, however, this poses a technical challenge of how to compress the spatial relationships of a road graph (or any other network feature graph) in 2D-space into a single dimensional vector.

In one embodiment, the system 100 provides for at least three alternative algorithms for linearizing a graph into a 1D vector which differ in terms of the criteria they use for optimizing this process.

By way of example, one criterion is to maintain spatial relationships/graph topological relations. For example, in a traffic estimation/prediction task, for a ML system 103 (e.g., using a ML model 105 such as a CNN) to more reliably capture the described spatial correlation patterns of traffic, the input as well as the output data format can maintain as much as possible the spatial relationship that exists in the original road network (e.g., map 101 as represented in the geographic database 111). In other words, the road segments that are topologically adjacent to each other in the road network usually have similar traffic conditions and therefore they should be also close to each other in the input/output vector (e.g., the linearized feature data 119). For another example, if a road segment A is the upstream of another road B (i.e., traffic flows from A to B), then it is desirable that B follows A in the input/output vector; this way the effect that a traffic slowdown in B would propagate to A may be captured.

Another criterion for optimizing the graph or network linearization process is to maintain spatio-temporal correlation structure of a phenomenon observed on the graph. For some use cases, the system 100 can define more complex relationships or correlations which go beyond pure network topological relations (adjacency) as detailed before. In many cases, data will be available which represents a particular spatio-temporal phenomenon occurring on the graph (e.g., data describing the spatio-temporal patterns of traffic flow in a city). If the downstream prediction task that the CNN is aiming to solve depends on it extracting such patterns from the input vector, its generation should aim to maintain the spatio-temporal correlation structure, i.e., road segments that are topologically adjacent and show a high correlation with regards to their traffic flow should be close to each other in the input/output vector.

A third criterion for optimizing the linearization of network feature data is to use ML to learn an optimal ordering of the edges in the 1D vector representation. More specifically, on one embodiment, an approach to generating the 1D vector (i.e., linearizing the network of features) does not need to be restricted by topology (e.g., first criterion discussed above) or correlation patterns (e.g., second criterion discussed above), but just be can learned by a ML model 105 directly while solving a representative, generalizable task.

To summarize, the various embodiments described herein addresses the technical problem of creating a linear order of road segments (or any other network feature such as but not limited to social networking connections, pipelines, etc.) from a network such that a selected criterion is preserved. As discussed above, the selected criterion can include, but is not limited to, their spatial/topological relationship, observed correlation structure, or optimal ordering to solve a particular ML task. The various example embodiments described herein may be used to create a linear order of any features from any type of network, e.g., facility (water pipe, oil pipe, electricity) networks, biological networks (e.g., the human brain), social networks, etc. In one embodiment, the various embodiments described herein can provide the basis for compressing/encoding any network data (usually represented by a 2D adjacency matrix) into a single dimension vector, which can serve both as input and as output format to a ML system 103 to provide inference data 107, for routing applications, visualizations of network features, and/or another service/application.

For example, in one embodiment, the linearized feature data 119 and/or inference data 107 can be provided as an output over a communication network 121 to other components of the system 100 such as, but not limited to: (1) a services platform 123 comprising one or more services 125a-125j (collectively referred to as services 125) such as one or more location-based services applications that perform functions based on the linearized feature data 119 and/or inference data 107; and (2) content provider platforms 127 that store the linearized feature data 119 and/or inference data 107 (e.g., for access by other components of the system 100) or provide data (e.g., sparse data 109) for generating the linearized feature data 119 and/or inference data 107. By way of example, the services 125 can be targeted to functions such as, but not limited to, traffic prediction and routing for deliver to end user devices such as, but not limited to, one or more user equipment (UE) devices 129, applications 131 executing on the UEs 129, vehicles 133, and/or the like. While the various embodiments described herein work well for the various use cases described above, it could be utilized for any other sparse spatial datasets or graph data as well.

In one embodiment, the various embodiments described herein are relevant to linear referencing. For example, linear referencing, also called linear reference system or linear referencing system (LRS), is a method of spatial referencing in engineering and construction, in which the locations of physical features along a linear element are described in terms of measurements from a fixed point, such as a milestone along a road. For road networks, a conventional linear referencing system provides a linear order of road segments that belong to the same road (e.g., all the road segments of a highway or interstate road). However, it does not provide a linear order of road segments from different roads. The various embodiments described herein, on the other hand, provide a linear order of all the road segments in the entire road network (or more generally, over all arcs/edges of the directed graph representation of a network of features).

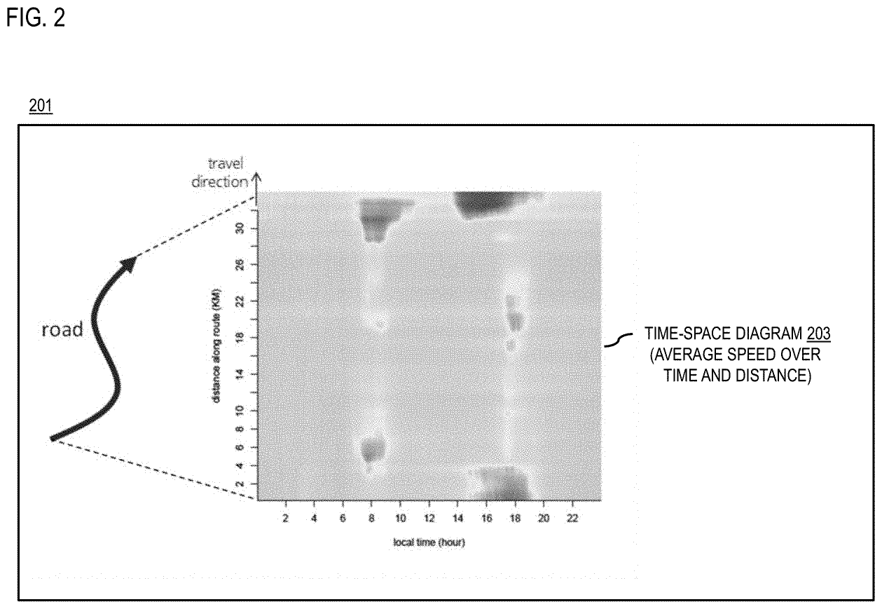

In one embodiment, the various embodiments are also relevant to time-space diagrams. A time-space diagram shows the traffic condition at different locations of a pathway over time. FIG. 2 illustrates an example 201 of a time-space diagram 203. Note that the y-axis in the time-space diagram 203 is a linear order of road segments and the x-axis is time. The time-space diagram 203 may be fed into a machine learning system (e.g., ML system 103) to predict future traffic speeds or other traffic attributes. Traditionally, the y-axis of a time-space diagram 203 is a linear representation of a single road or roads that form circles. In these cases, it is trivial to sequentialize road segments. In contrast, the various embodiments described herein can be used to automatically create a linear representation (e.g., 1D vector representation) of an arbitrarily complex road network, and thus, in one embodiment, enables the creation of time-space diagrams at scale to represent the traffic condition over time for the entire road network.

In one embodiment, the various embodiments described herein are also relevant to CNNs or equivalent machine learning model 105. A CNN is a particular type of Neural Network where—in contrast to fully connected networks—stacked convolutional layers extract patterns of increasing complexity by convolving the values in the neighborhood of an input value or output of a previous hidden layer (whereas the neighborhood size is defined by the shape of the used filter. In a road network use case, the various embodiments described herein can be used to assign each road segment a 1D code so that the road segments that are adjacent or correlated to each other are close by in the 1D space.

The various embodiments described herein may also be related to graph embedding that translates the graph structure (or parts of graphs) of a network of features to a lower-dimensional vector. By way of example, different graph embedding techniques exist and can be used depending on the aspect of representation, e.g., node2vec for representing nodes/edges or graph2vec for representing the entire graph. In one embodiment, the various embodiments described herein are related to node2vec as the system 100 traverses all the nodes/edges in the graph. In another embodiment, the various embodiments can also be related to graph2vec, in the sense that the system 100 linearizes the nodes in the entire graph. However, different from previously mentioned approaches, the various embodiments described herein does not learn features which represent the graph elements, but rather orders graph elements into an optimal permutation of size N, where N is equal or larger to the number of graph elements.

The various embodiments described herein are also relevant for routing applications. From the routing perspective, the correlation maximizing approach for linearizing network features actually leads to finding a route through the entire network where at each decision point the system 100 chooses the road alternative where a certain process is more similar to the road a user or vehicle is currently traveling on. Thus, the various embodiments described herein could be used for route planning, e.g., for delivery trucks and garbage collecting vehicles. For example, when planning the routes for delivery trucks, it may be desirable that a truck drops off large items first and then small items (e.g., for energy saving). Based on the distribution of items weights on each road segment and how this distribution changes over time of day, the various embodiments described herein can make a route schedule so that the truck delivers to the road segment with many large items first and then those with many small items. Similarly, when diagnosing a facility network such as a water supply network and an electrical grid, the various embodiments described can be used to plan a route that travels through the network such that the links with high failure rates are traveled before the links with low failure rates. The same idea may also be used for the modeling of signal navigation in a brain network such that a signal travels the neurons in an order based on their functional correlations.

With respect to a road network use case, the various embodiments include at least three methods to organize all road segments in a road network in a sequence or linear order.

The first method is to find a path that passes every road segment exactly once. Such a path is known as a Eulerian path. The Eulerian path preserves spatial relationship in the sense that the road segments that are adjacent in the Eulerian path are also adjacent in the road network. In addition, since the order of nodes in each arc follows the travel direction, the Eulerian path reflects the flow of traffic in the network. That is, if a first arc appears later in the Eulerian path than a second arc, then an increase of traffic volume in the second arc may propagate to the first arc. Similarly, a traffic jam that occurs in arc the first arc may propagate back to the second arc. Furthermore, the closer the first and second arcs are to each other in the Eulerian path, the more directly they will influence each other's traffic condition. In the case that a Eulerian path does not exist, artificial arcs may be added such that the condition for Eulerian path is satisfied. A downside of Eulerian path is that since it merely follows the travel direction of the nodes or relies on hand-crafted rules which approximate traffic flow patterns, the order of the nodes can still be further optimized (e.g., based on real traffic data).

In one embodiment, the second method below therefore employs a data-driven approach to reflect the ‘real’ flow of traffic among the nodes. Therefore, the aim is to identify the best linear order of road segments based on the observed traffic flow correlations between these road segments, such that the road segments that are highly correlated on traffic flow are adjacent to each other in the linear order.

In one embodiment, the third method avoids any defined rules and designs a Neural Network in a way to allow it to learn an optimal ordering of road segments in the vector (implemented via learning an imputation matrix) while solving a representative, generalizable task.

The various embodiments described herein provide for several technical advantages including but not limited to the advantages described below.

Conventional solutions generate a linear referencing system for a single road or a trivial sequence of roads (e.g., circles). This invention generates a linear referencing system for an entire road network.

The various embodiments described herein translate complex input graphs into a vector (with a length in the order of the number of elements in the graph). The translation or linearization of the network features essentially compresses the graph into a simpler data structure while preserving the feature correlations among the elements that are relevant to the objective tasks.

The correlation maximizing approach of the various embodiments described herein finds a route through the entire network where at each decision point the system 100 chooses the road alternative where a certain process is more similar to the road we are currently traveling on. Thus, the various embodiments described herein can be used for route planning, e.g., for delivery trucks, garbage collecting vehicles, fault detection in power grids and other facility networks.

The various embodiments described herein can be employed in multiple scenarios, where different criteria need to be satisfied (e.g., network adjacency, data correlation, or neural encoding)

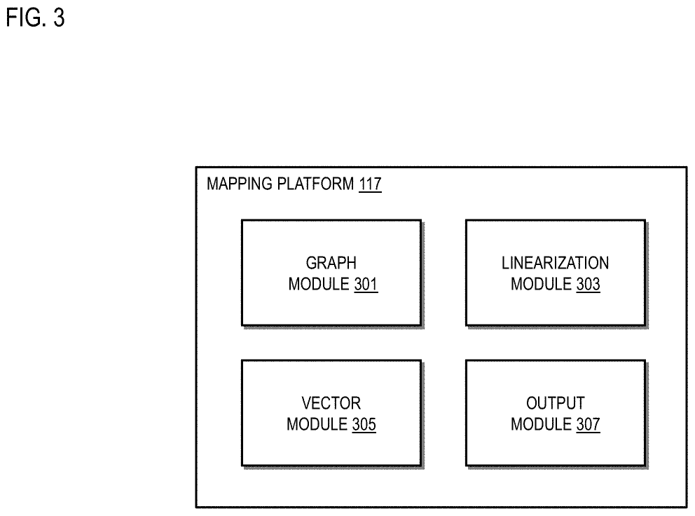

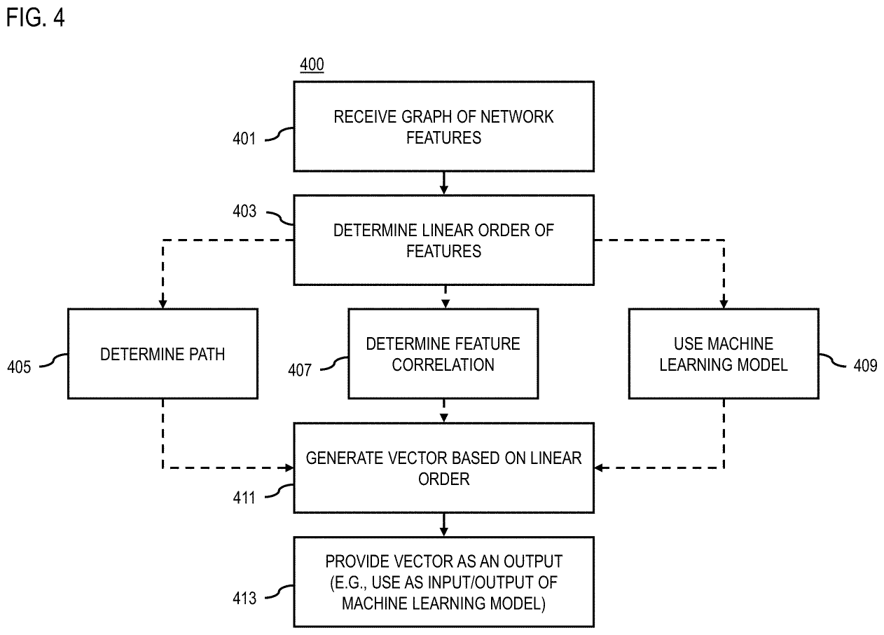

FIG. 3 is a diagram of components of a mapping platform capable of linearizing a network of features for machine learning tasks, according to one embodiment. In one embodiment, as shown in FIG. 3, the mapping platform 117 of the system 100 includes one or more components for linearizing a network of features for machine learning tasks according to the various embodiments described herein. It is contemplated that the functions of the components of the mapping platform 117 may be combined or performed by other components of equivalent functionality. As shown, in one embodiment, the mapping platform 117 includes a graph module 301, a linearization module 303, a vector module 305, and an output module 307. The above presented modules and components of the mapping platform 117 can be implemented in hardware, firmware, software, or a combination thereof. Though depicted as a separate entity in FIG. 1, it is contemplated that the mapping platform 117 may be implemented as a module of any of the components of the system 100 (e.g., a component of the machine learning system 103, services platform 123, services 125, content providers 127, UEs 129, vehicles 133, and/or the like). In another embodiment, one or more of the modules 301-307 may be implemented as a cloud-based service, local service, native application, or combination thereof. The functions of the mapping platform 117 and modules 301-307 are discussed with respect to FIGS. 4-9 below.

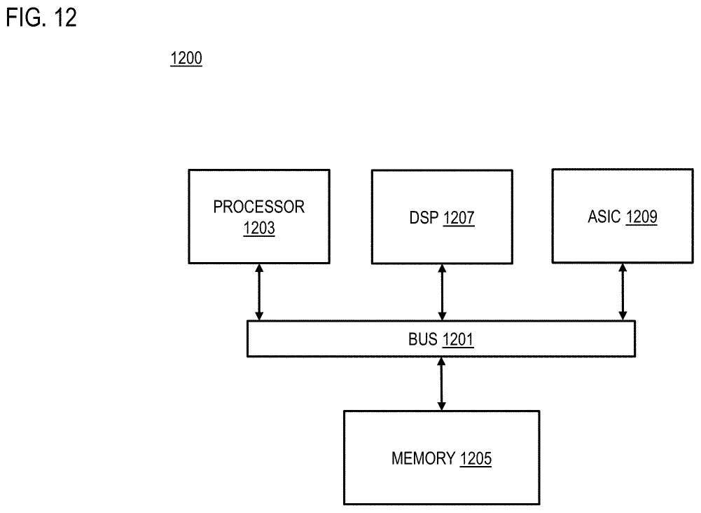

FIG. 4 is a flowchart of a process for a network of features for machine learning tasks or equivalent applications, according to one embodiment. In various embodiments, the mapping platform 117 and/or any of the modules 301-307 may perform one or more portions of the process 400 and may be implemented in, for instance, a chip set including a processor and a memory as shown in FIG. 12. As such, the mapping platform 117 and/or any of the modules 301-307 can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps.

In step 401, the graph module 301 receives a graph representation of a network of a plurality of features. The network can be a collection or set of multiple features of interest. The specific feature of interest can depend on the type of data and service, or application being performed. For example, as discussed about, one example of a network includes but is not limited to a road network in which the features of interest include but are not limited to road segments and/or intersections (or equivalent node points) that define the extent of the road segments. Other examples of a network include but are not limited to social networks, brain topology/neuron connectivity paths. A graph representation can then represent the features of the graphs as vertices and/or the connections between the vertices. In other words, a plurality of vertices of the graph representation, an edge connecting two vertices of the plurality of vertices, or a combination thereof respectively represents the plurality of features. The topology or relationships of the vertices and edges can be used to represent spatial and/or temporal relationships and/or any other correlation or relationship between the features represented in the graph. For example, in a road network, the plurality of features of the network is a plurality of road segments in the road network. Each vertex in the graph can represent an intersection and the arcs or edges of the graph can represent the road segments.

In step 403, the linearization module 303 determines a linear order of the plurality of features based on a selected criterion. The selected criterion is a property or characteristic of the features that can be used for sequencing or ordering the multiple features into a linear sequence. Examples of the selected criterion include but is not limited to: (1) spatial relationship or graph topology; (2) feature correlation; and (3) ML predicted ordering.

As shown in FIG. 4, step 403 can be performed using one or more optional steps based on the selected criterion. For example, step 405 describes an embodiment that creates a linear order of road segments by finding a Eulerian path. Step 407 describes a process that creates a linear order that maintains the feature correlation (e.g., spatial correlation structure of traffic). Step 409 describes a method that creates a linear order by machine learning. Each of these steps for determining a linear order of features is described in more detail below.

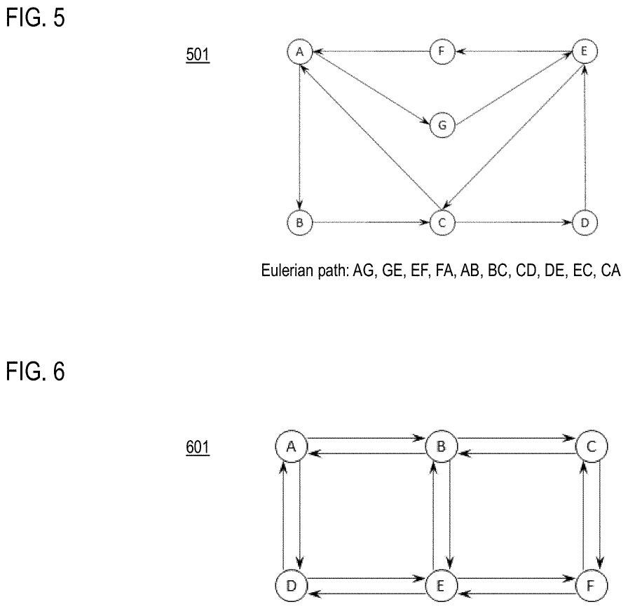

In one embodiment of step 405, the selected criterion is a spatial relationship or a graph topology. The linearization module 303 determines a path that passes each edge or arc of the graph representation exactly once (e.g., a Eulerian path or equivalent). The linear order is then based on the path. In one embodiment, the graph representation is a directed graph that defines a direction of traversal between the plurality of vertices, and wherein the path is determined based on the direction of traversal. For a vertex in a directed graph (e.g., representing a network of features), the number of arcs coming into the vertex is called the indegree of the vertex and the number of arcs going out from the vertex is its outdegree. A directed graph has a Eulerian path if and only if at most one vertex has outdegree—indegree=1, at most one vertex has indegree—outdegree=1, and every other vertex has equal indegree and outdegree. FIG. 5 shows a graph 501 such that every vertex has equal indegree and outdegree. Specifically, vertices A, C, E each have two incoming arcs and two outgoing arcs; vertices B, D, F, G each have one incoming arc and one outgoing arc. The graph has a Eulerian path which is (AG, GE, EF, FA, AB, BC, CD, DE, EC, CA). FIG. 6 shows graph 601 representing a typical part of a road network wherein every vertex has equal indegree and outdegree and therefore has a Eulerian path. The road network shown in FIG. 6 has a Eulerian path (AD, DE, EB, BA, AB, BC, CB, BE, EF, FC, CF, FE, ED, DA).

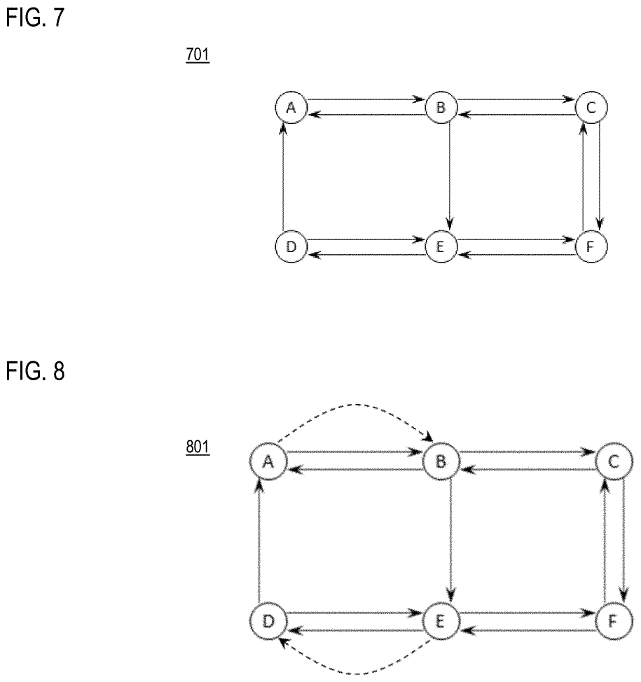

On the other hand, in the graph 701 shown in FIG. 7, there are more than one vertex (B and D) having outdegree—indegree=1 and more than one vertex (A and E) having indegree—outdegree=1, and therefore the graph does not have a Eulerian path. Observe that if an arc from A to D and an arc from E to B were added, then the graph has a Eulerian path.

In the case that a graph does not have a Eulerian path, artificial arcs may be added such that all vertices have equal outdegree and indegree. For example, by adding an artificial arc from A to B and an artificial arc from E to D as shown in the graph 801 of FIG. 8, the new graph 801 has a Eulerian path. It is contemplated that any procedure for adding artificial arcs that results in all vertices having equal outdegree and indegree can be used. One example process comprises determining the difference in of the outdegree and indegree of each vertex. A vertex with a difference of 0 is balanced, and a vertex with a difference not equal to 0 is imbalanced. A vertex with a negative difference value can be offset by adding that an artificial path that originates from the vertex, which increases the difference value by 1 for each added artificial path or arc, until the difference is zero. Then a vertex with a positive difference value can be offset by adding an artificial path that ends at the vertex which will decrease the difference value by 1 for each added artificial path or arc until the difference is 0. The positive and negative difference vertices can be matched and balanced by the added artificial paths or arcs until all vertices have equal outdegree and indegree. Then the resulting graph with added artificial paths or arcs has a Eulerian path.

In the example graph 801 of FIG. 8, artificial arcs (indicated by dashed lines) are added to the original graph 701 shown in FIG. 7. The new graph 801 has a Eulerian path (AB, BC, CB, BA, AB (dashed arc), BE, EF, FC, CF, FE, ED, DE, ED (dashed arc), DA). This path can serve as a linear representation of the graph 701 shown in FIG. 7.

In one embodiment, another possibility to overcome this issue is to decompose the graph into multiple sub-graphs, such that each sub-graph has a Eulerian Path.

In step 411, the vector module 305 can generate a vector representation of the plurality of features based on the linear order indicated in the Eulerian path determined from the graph. In one embodiment, it is desirable that an arc appears exactly once in the linear representation. This can be achieved by removing all artificial arcs from the Eulerian path. In the example graph 801 of FIG. 8, after deduping (namely removing repeated occurrences of an arc such that each arc appears exactly once), the linear representation will be (AB, BC, CB, BA, BE, EF, FC, CF, FE, ED, DE, DA). Notice that after deduping, the sequence might become disconnected, however that will not be an issue for the output vector. The linear representation will be the order of the feature (e.g., road segment) corresponding to each arc as they will appear in the corresponding vector (e.g., 1D vector).

In another embodiment, a Eulerian path is regulated so that the path uses through maneuvers of intersections and avoids left/right turns whenever possible (or applies any other turn regulation rule). This way the continuity of traffic flow is preserved as usually the through traffic occupies most of the traffic in an intersection. The regulation is done by adding costs to all turns in order of through, right turn, left turn and U-turn, particularly adding highest costs to U-turns. The goal of regulation is to find a Eulerian path with minimum total turn cost. In one embodiment, the turn cost is negatively correlated with the fraction of traffic that follows a turn relative to other turns. In other words, in a road network use, the path can be determined further based on turn probability data (e.g., based on observed historical data indicated which turns are taken at a particular intersection). For example, if it is known (e.g., via historical traffic data) that 80%, 15%, 4%, 1% of vehicles that approach an intersection from west go through, turn right, turn left, or U-turn, respectively, then the cost may be 0.01, 0.04, 0.15, 0.8, for through, right turn, left turn, and U-turn, respectively. Such a turn cost assignment would guide the Eulerian path to minimize the number of turns and particularly U-turns and left turns. In the case that turn fraction data is not available, some empirical rules may be used, e.g., 0.01, 0.09, 0.1, 0.8 for through, right turn, left turn, and U-turn, respectively. In another embodiment, the turn cost is measured by the turn angle.

For the graph 601 of FIG. 6, a regulated Eulerian path would be the following sequence: AB, BC, CF, FE, ED, DE, EF, FC, CB, BE, EB, BA, AD, DA.

In one embodiment, finding a Eulerian path with minimum total turn cost can be transformed to a traveling salesman problem. The transformation process can proceed as follows. Construct a directed graph G′ such that:
(1) each road link in G is a vertex in G′;
(2) for each turn from a road link u to a road link v in G, there is an arc (u, v) in G′; and
(3) the cost of each arc (u, v) in G′ is equal to the turn cost from road link u to road link v.

Now find a minimum cost path in G′ that visits every vertex exactly once, which is a Traveling Salesman Problem (TSP) path. This path gives a Eulerian path in G with minimum total turn cost. Notice that traditionally TSP and TSP algorithms are defined on a complete graph whereas G′ may be an incomplete graph. An approximation algorithm can then be used for solving TSP on an incomplete graph. It is noted that strictly speaking, this is not exactly a TSP path since a TSP path must return to the origin node whereas returning is not wanted in our problem. However, in one embodiment, the linearization module 303 can create a dummy node in the graph such that its distances to every other node is 0. The linearization module 303 can then solve the TSP with this dummy node being the origin node. After solving, the linearization module 303 deletes the dummy node from the resultant path and the remaining path is what we want.

In one embodiment, the turn cost can be replaced by other measures that reflect the relationship between the adjacent links and the method still applies. For example, the turn cost can be replaced by the traffic correlation between two adjacent links and in this case our method can be adapted to find a Eulerian path such that the sum of the traffic correlation is maximized.

In one embodiment, as shown in step 407, feature correlation (e.g., traffic correlation) can be used as a linearization criterion in addition to or in place of the spatial relationship/graph topology criterion of step 405. More specifically, the linearization module 303 uses feature correlation as the selected criterion and determines a feature correlation among the features in the graph based on a designated property of the features (e.g., traffic flow property, traffic volume property, and/or any other physical attribute of the feature such as functional class, etc. for a road segment feature). The linear order can then be based on the feature correlation (e.g., more highly correlated or matching property values are grouped more closely together in the linear order.

Although the described Eulerian path-based embodiments of step 405 aim to take plausible traffic flow through the network into account, in certain real-world settings the actual traffic flow patterns might differ from any set of general rules. Thus, when comparing the degree of correlation between neighboring road links in the Eulerian path-based sequence with real traffic flow characteristics—as observable by large scale traffic data—there can be cases where the generated linear sequence or order of features proves suboptimal. For instance, actual traffic flow might not always avoid left turns associated with higher cost, but be determined by highly dynamic, local rules.

For cases where large-scale traffic data (e.g., probe data) is available, step 407 provides an alternative approach where optimal sequences of road links are learned based on correlations of traffic flow characteristics observable directly from the data. Thus, an optimization algorithm could predict a potential sequence of road links independent of actual adjacency (e.g., topological connectedness of links) simply based on the strength of their observed correlation with regards to the traffic state (e.g., the dynamics of the average traffic speed and/or volume).

For this, the process of step 407 evaluates the (relative) quality of a proposed sequence to serve as an objective function for the optimization procedure. In general, there are several options for calculating this, but a straight-forward metric could be the sum of absolute per-neighbor correlations across the entire sequence:
Based on historical traffic data, each road link of a graph (e.g., the graph 601 of FIG. 6) is attributed a time series of traffic states (e.g., average speed), such that e.g., with respect to the graph 601, AB→[30, 35, 50, 25] where each value refers to the traffic speed in kph at a certain point in time.
An optimization algorithm proposes a sequence AB, BC, CF, FE, ED, DE, EF, FC, CB, BE, EB, BA, AD, DA.
Based on the traffic state data per road link, an evaluation algorithm calculates the correlation r_{AB,BC} (e.g., the Pearson correlation coefficient) between links in the sequence with a sliding window of size=2, e.g., corr(AB, BC)→r_{AB,BC}.
The sum of absolute correlation values across the entire sequence represents the overall evaluation metric for this proposed sequence, and should be maximized

In one embodiment, the optimization algorithm could be both deterministic and stochastic, and include e.g., ML techniques such as evolutionary algorithms.

For example, the above optimization problem can be formulated as a traveling salesman problem (TSP) and thus be solved by an existing TSP algorithm. Specifically, construct an undirected graph G′ such that
(1) each road link in G is a vertex in G″;
(2) for each pair of road links u and v in G there is an edge (u, v) in G″ (i.e., G″ is a complete graph); and
(3) the cost of each edge (u, v) in G″ is equal to 1-|corr(u, v)|.

Now find a minimum cost path in G″ that visits every vertex exactly once, which is a TSP path. The sequence of vertices in this path can be the road line sequence that is used as the linear order for generating the vector as it minimizes the sum of 1-|corr(u,v)| and therefore maximizes the sum of |corr(u,v)|. Since TSP optimization is NP-hard, an approximation algorithm may be used.

In another embodiment, in addition to or in place of steps 405 and/or 407, the linearization module 303 can use a trained machine learning model as shown in step 409. For example, a machine learning model can be designed to take the output of the Eulerian path or any random sequence of the arcs in the network as input and solve one or more representative, generalizable tasks (e.g., predicting future traffic, anomaly detection). In practice, these tasks can be any regression or classification tasks, ideally, however, they should be representative to a larger class of other tasks (i.e., require extracting similar patterns), and therefore generalizable.

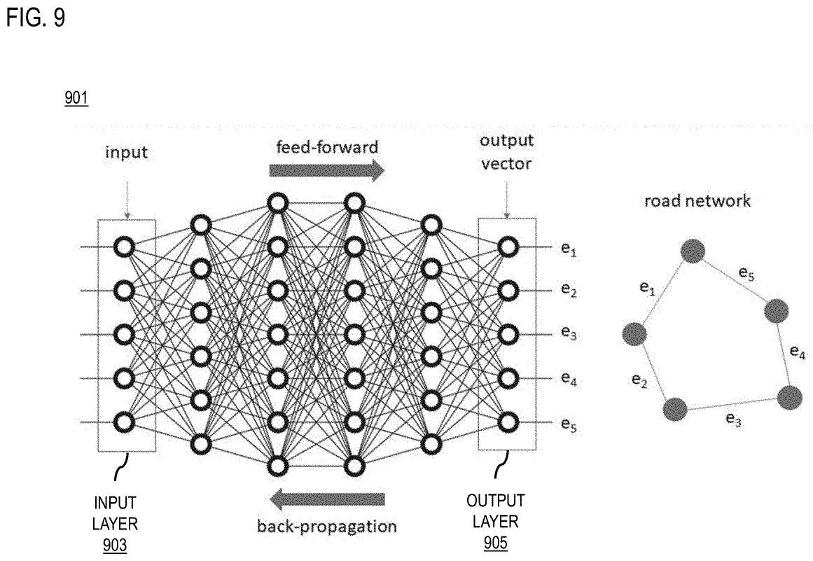

FIG. 9 illustrates an example neural network 901 for traffic estimation/prediction that can be used to determine an optimal linear order a network of features, according to one embodiment. In this example, the neural network 901 has an input layer 903 that receives an input vector of features (e.g., sequence of road segments) and produces an output vector 905 comprising a sequence of road segments based on the ML task being performed. In one embodiment, the neural network 901 can be designed as follows:
The first layer of the neural network 901 learns a permutation matrix, which is then multiplied with the input vector received via the input layer 903 resulting in a reshuffling of the input vector, while keeping the vector values unchanged; and
The shuffled vector is then provided as input to one or more subsequent 1D convolutional layers which generate the prediction output(s).

After training the model end-to-end, the learned permutation matrix can be extracted and used to reorder the vector for other ML models and/or any other use cases. For example, one machine learning model is trained using a general task and learns the permutation matrix at the same time. By way of example, the loss of the final result is backpropagated to train the one or more machine learning model. This permutation matrix can then be used to order the graph elements as input for another machine learning model which solves a different, specialized task. In case of multiple tasks solved by the model simultaneously, the losses of individual tasks must be combined for backpropagation. In one embodiment, a permutation matrix may be learned via techniques other than deep or traditional machine learning approaches. In one embodiment, the permutation matrix can be learned for one ML model or task and then implemented in another ML model or task.

In step 411, after the linear order of network features (e.g., linear order of road segments) is determined (e.g., according to the embodiments of steps 403, 405, 407, and/or 409), the vector module 305 can generate a vector representation of the network features based on the linear order. For example, the linear order may specify a sequence of arcs of the graph of features (e.g., road segments) corresponding to the arcs. Then the feature vector can be generated so that the features are included in the vector in the same order as the determined linear order. In one embodiment, the vector is a 1D vector that represents the features (e.g., road segments) of a 2D graph or network. However, it is also contemplated that the generated vector representation can be any higher dimensional vector representation. For example, in one example, the generated vector representation can have dimensions less than the number of dimensions of the graph representation of the network features (e.g., a 1D or 2D vector representation of a 3D feature graph; a 1D, 2D, or 3D vector representation of a 4D feature graph, etc.). In another example, the vector representation can have the same number of dimensions as the graph representation, but with a smaller size. For example, an adjacency matrix in a 2-D network is size of N*N (N being number of nodes/edges) and the resulting vector representation could be 2*N or 3*N, so still 2-D but much smaller size. It is noted that the above examples of vector representations are provided by way of illustration and not as limitations. It is contemplated that the dimensionality of the vector representation can vary depending on application and/or type of features (e.g., a road network or other type of network) being represented.

In step 413, the output module 307 provides the vector representation (e.g., vector of linearized features) as an output for that can be used for any number of services and/or applications (e.g., as previously described). For example, the linearized feature data 119 can be provided to any of the components of the system 100 including but not limited to the ML system 103, ML model 105, services platform 123, services 125, content providers 127, vehicles 133, UEs 129, and/or the like. In another embodiment, the vector representation can be used as an input, an output, or a combination thereof of a ML model 105.

Returning to FIG. 1, as shown, the system 100 includes a mapping platform 117 for linearizing a network of features for machine learning task. In one embodiment, the mapping platform 117 processes sparse data 109 to generate linearized feature data 119 (e.g., 1D vector representations) that can be used as inputs/outputs of the ML system 103. The ML system 103 includes or is otherwise associated with one or more machine learning models 105 (e.g., neural networks or other equivalent networks) for performing ML tasks relying on the linearized feature data 119 generated according to the embodiments described herein.

In one embodiment, the mapping platform 117 has connectivity over the communication network 121 to the machine learning system 103, services platform 123 that provides one or more services 125 that can use linearized feature data 119 for downstream machine learning tasks to perform one or more functions. By way of example, the services 125 may be third party services and include but is not limited to mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 125 uses the output of the mapping platform 117 (e.g., linearized feature data 119) and/or machine learning system 103 (e.g., inference data 107) to provide services 125 such as navigation, mapping, other location-based services, etc. to the vehicles 133, UEs 129, and/or applications 131 executing on the UEs 129.

In one embodiment, the mapping platform 117 may be a platform with multiple interconnected components. The mapping platform 117 may include multiple servers, intelligent networking devices, computing devices, components, and corresponding software for combining location data sources according to the various embodiments described herein. In addition, it is noted that the mapping platform 117 may be a separate entity of the system 100, a part of the machine learning system 103, one or more services 125, a part of the services platform 123, or included within components of the vehicles 133 and/or UEs 129.

In one embodiment, content providers 127 may provide content or data (e.g., including network feature data, graph data, geographic data, etc.) to the geographic database 111, machine learning system 103, the mapping platform 117, the services platform 123, the services 125, the vehicles 133, the UEs 129, and/or the applications 131 executing on the UEs 129. The content provided may be any type of content, such as machine learning models, permutations matrices, map embeddings, map content, textual content, audio content, video content, image content, etc. In one embodiment, the content providers 127 may provide content that may aid in compressing data according to the various embodiments described herein. In one embodiment, the content providers 127 may also store content associated with the machine learning system 103, geographic database 111, mapping platform 117, services platform 123, services 125, and/or any other component of the system 100. In another embodiment, the content providers 127 may manage access to a central repository of data, and offer a consistent, standard interface to data, such as a repository of the geographic database 111.

In one embodiment, the vehicles 133 and/or UEs 129 may execute software applications 131 to used linearized feature data 119 and/or inference data 107 according to the embodiments described herein. By way of example, the applications 131 may also be any type of application that is executable on the vehicles 133 and/or UEs 129, such as autonomous driving applications, routing applications, mapping applications, location-based service applications, navigation applications, device control applications, content provisioning services, camera/imaging application, media player applications, social networking applications, calendar applications, and the like. In one embodiment, the applications 131 may act as a client for the mapping platform 117 and perform one or more functions associated with compressing data for machine learning or equivalent tasks alone or in combination with the mapping platform 117.

By way of example, the vehicles 133 and/or UEs 129 is or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the vehicles 133 and/or UEs 129 can support any type of interface to the user (such as “wearable” circuitry, etc.). In one embodiment, the vehicles 133 and/or UEs 129 may be associated with or be a component of a vehicle or any other device.

In one embodiment, the vehicles 133 and/or UEs 129 are configured with various sensors for generating or collecting environmental image data, related geographic data, etc. In one embodiment, the sensed data represent sensor data associated with a geographic location or coordinates at which the sensor data was collected, and the polyline or polygonal representations of detected objects of interest derived therefrom to generate the digital map data of the geographic database 111. By way of example, the sensors may include a global positioning sensor for gathering location data (e.g., GPS), IMUs, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the vehicles 133 and/or UEs 129 may include light sensors, orientation sensors augmented with height sensors and acceleration sensor, tilt sensors to detect the degree of incline or decline (e.g., slope) along a path of travel, moisture sensors, pressure sensors, etc. In a further example embodiment, sensors about the perimeter of the vehicles 133 and/or UEs 129 may detect the relative distance of the device or vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the vehicles 133 and/or UEs 129 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 121 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the machine learning system 103, mapping platform 117, services platform 123, services 125, vehicles 133 and/or UEs 129, and/or content providers 127 communicate with each other and other components of the system 100 using well known, new or still developing protocols. In this context, a protocol includes a set of rules defining how the network nodes within the communication network 121 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

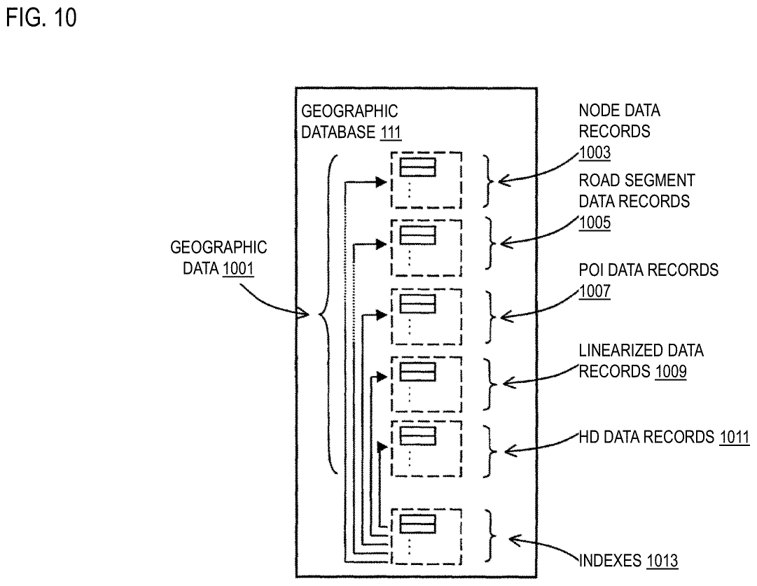

FIG. 10 is a diagram of a geographic database 111, according to one embodiment. In one embodiment, the geographic database 111 includes geographic data 1001 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the geographic data 1001. In one embodiment, the geographic database 111 include high definition (HD) mapping data that provide centimeter-level or better accuracy of map features. For example, the geographic database 111 can be based on Light Detection and Ranging (LiDAR) or equivalent technology to collect billions of 3D points and model road surfaces and other map features down to the number lanes and their widths. In one embodiment, the HD mapping data (e.g., HD data records 1011) capture and store details such as the slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database 111.

“Node”— A point that terminates a link.

“Line segment”— A straight line connecting two points.

“Link” (or “edge”)— A contiguous, non-branching string of one or more line segments terminating in a node at each end.

“Shape point”— A point along a link between two nodes (e.g., used to alter a shape of the link without defining new nodes).

“Oriented link”— A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 111 follows certain conventions. For example, links do not cross themselves and do not cross each other except at a node. Also, there are no duplicated shape points, nodes, or links. Two links that connect each other have a common node. In the geographic database 111, overlapping geographic features are represented by overlapping polygons. When polygons overlap, the boundary of one polygon crosses the boundary of the other polygon. In the geographic database 111, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 111 includes node data records 1003, road segment or link data records 1005, POI data records 1007, linearized data records 1009, HD mapping data records 1011, and indexes 1013, for example. More, fewer, or different data records can be provided. In one embodiment, additional data records (not shown) can include cartographic (“carto”) data records, routing data, and maneuver data. In one embodiment, the indexes 1013 may improve the speed of data retrieval operations in the geographic database 111. In one embodiment, the indexes 1013 may be used to quickly locate data without having to search every row in the geographic database 111 every time it is accessed. For example, in one embodiment, the indexes 1013 can be a spatial index of the polygon points associated with stored feature polygons. In one or more embodiments, data of a data record may be attributes of another data record.

In exemplary embodiments, the road segment data records 1005 are links or segments representing roads, streets, or paths, as can be used in the calculated route or recorded route information for determination of one or more personalized routes. The node data records 1003 are end points (for example, representing intersections or an end of a road) corresponding to the respective links or segments of the road segment data records 1005. The road link data records 1005 and the node data records 1003 represent a road network, such as used by vehicles, cars, and/or other entities. Alternatively, the geographic database 111 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 111 can include data about the POIs and their respective locations in the POI data records 1007. The geographic database 111 can also include data about places, such as cities, towns, or other communities, and other geographic features, such as bodies of water, mountain ranges, etc. Such place or feature data can be part of the POI data records 1007 or can be associated with POIs or POI data records 1007 (such as a data point used for displaying or representing a position of a city).

In one embodiment, the geographic database 111 can also include linearized data records 1009 for storing linearized feature data 119, linearization criteria, feature correlations (e.g., traffic flow, traffic volume, etc.), trained ML models 105, and/or any other related data that is used or generated according to the embodiments described herein. By way of example, the linearized data records 1009 can be associated with one or more of the node records 1003, road segment records 1005, and/or POI data records 1007 to associate the linearized data records 1009 with specific places, POIs, geographic areas, and/or other map features. In this way, the linearized data records 1009 can also be associated with the characteristics or metadata of the corresponding records 1003, 1005, and/or 1007.

In one embodiment, as discussed above, the HD mapping data records 1011 model road surfaces and other map features to centimeter-level or better accuracy. The HD mapping data records 1011 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 1011 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 1011 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 1011.

In one embodiment, the HD mapping data records 1011 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic database 111 can be maintained by the content provider 127 in association with the services platform 123 (e.g., a map developer). The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 111 can be a master geographic database stored in a format that facilitates updating, maintenance, and development. For example, the master geographic database or data in the master geographic database can be in an Oracle spatial format or other format (e.g., capable of accommodating multiple/different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by vehicles 133 and/or UEs 129. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for linearizing a network of features for machine learning tasks may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

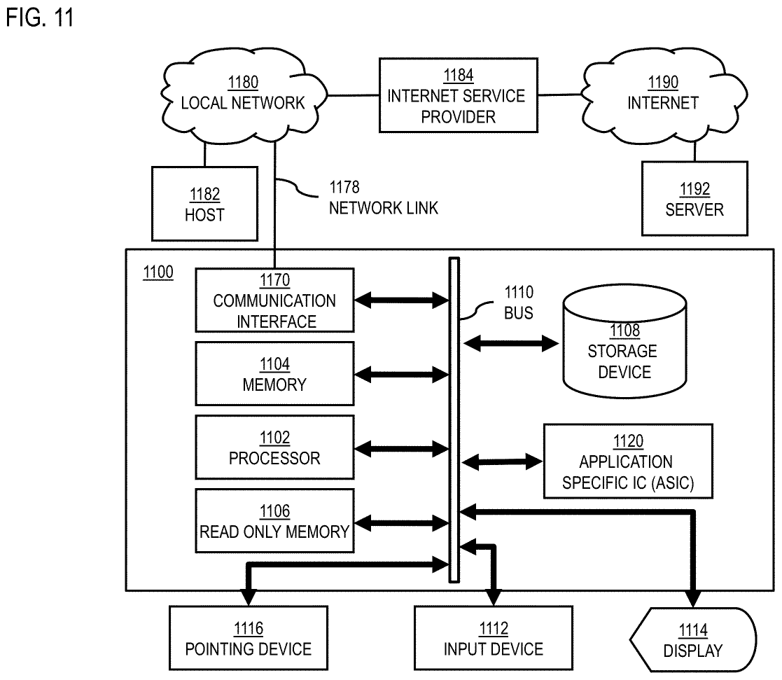

FIG. 11 illustrates a computer system 1100 upon which an embodiment of the invention may be implemented. Computer system 1100 is programmed (e.g., via computer program code or instructions) to linearize a network of features for machine learning tasks as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to linearizing a network of features for machine learning tasks. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random access memory (RAM) or other dynamic storage device, stores information including processor instructions for linearizing a network of features for machine learning tasks. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for linearizing a network of features for machine learning tasks, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general, the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 121 for linearizing a network of features for machine learning tasks.

The term computer-readable medium is used herein to refer to any medium that participates in providing information to processor 1102, including instructions for execution. Such a medium may take many forms, including, but not limited to, non-volatile media, volatile media and transmission media. Non-volatile media include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system can be deployed in various configurations within other computer systems, e.g., host 1182 and server 1192.

FIG. 12 illustrates a chip set 1200 upon which an embodiment of the invention may be implemented. Chip set 1200 is programmed to linearize a network of features for machine learning tasks as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to linearize a network of features for machine learning tasks. The memory 1205 also stores the data associated with or generated by the execution of the inventive steps.

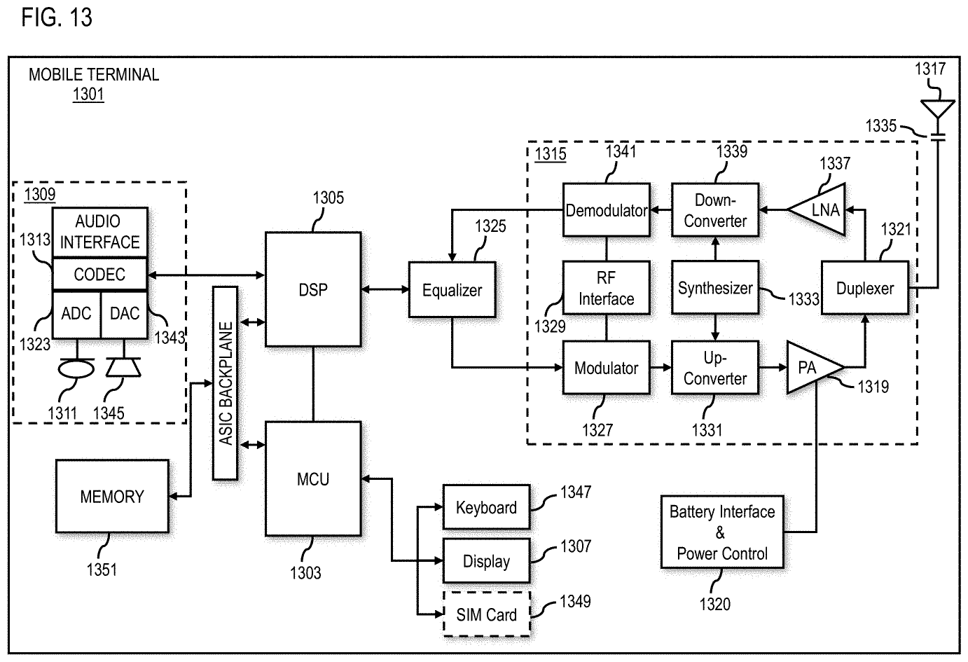

FIG. 13 is a diagram of exemplary components of a mobile terminal 1301 (e.g., a vehicle 133 and/or UE 129 or component thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile station functions that offer automatic contact matching. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile station 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, other mobile phone or a landline connected to a Public Switched Telephone Network (PSTN), or other telephony networks.

Voice signals transmitted to the mobile station 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303—which can be implemented as a Central Processing Unit (CPU) (not shown).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile station 1301 to linearize a network of features for machine learning tasks. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the station. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile station 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1351 may be, but not limited to, a single memory, CD, DVD, ROM, RAM, EEPROM, optical storage, or any other non-volatile or non-transitory storage medium capable of storing digital data.

An optionally incorporated SIM card 1349 carries, for instance, important information, such as the cellular phone number, the carrier supplying service, subscription details, and security information. The SIM card 1349 serves primarily to identify the mobile station 1301 on a radio network. The card 1349 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method comprising:
receiving a graph representation of a network of a plurality of features, wherein a plurality of vertices of the graph representation, an edge connecting two vertices of the plurality of vertices, or a combination thereof respectively represents the plurality of features;
determining a linear order of the plurality of features based on a selected criterion;
generating a vector representation of the plurality of features based on the linear order; and
using the vector representation as an input, an output, or a combination thereof of a machine learning model.

2. The method of claim 1, wherein the network is a road network, and wherein the plurality of features is a plurality of road segments in the road network.

3. The method of claim 1, wherein the selected criterion is a spatial relationship or a graph topology, the method further comprising:
determining a path that passes through each edge of the graph representation exactly once,
wherein the linear order is based on the path.

4. The method of claim 3, wherein the graph representation is a directed graph that defines a direction of traversal between the plurality of vertices, and wherein the path is determined based on the direction of traversal.

5. The method of claim 3, wherein the network is a road network, and wherein the path is further based on turn probability data.

6. The method of claim 1, wherein the selected criterion is a feature correlation, the method further comprising:
determining the feature correlation among the plurality of features based on a designated property of the plurality of features,
wherein the linear order is based on the feature correlation.

7. The method of claim 6, wherein the network is a road network, and wherein the designated property is a traffic flow, a traffic volume, or a combination thereof.

8. The method of claim 6, wherein the network is a road network, and wherein the designated property is a physical attribute of a road segment.

9. The method of claim 1, wherein the linear order is determined using a trained machine learning model.

10. The method of claim 9, wherein the trained machine learning model learns a permutation matrix to reorder an input vector to the linear order.

11. The method of claim 10, further comprising:
extracting the permutation matrix from a trained machine learning model; and
implementing the extracted permutation matrix in another machine learning model.

12. The method of claim 1, wherein the network is a social network; and wherein the plurality of features is associated with one or more members of the social networks, relationship data between the one or more members, or a combination thereof.

13. The method of claim 1, wherein the vector representation is a one-dimensional vector representation.

14. An apparatus comprising:
at least one processor; and
at least one memory including computer program code for one or more programs,
the at least one memory and the computer program code configured to, with the at least one processor, cause the apparatus to perform at least the following,
receive a graph representation of a network of a plurality of features;
determine a linear order of the plurality of features based on a graph topology, a feature correlation, or a combination thereof;
generate a vector representation of the plurality of features based on the linear order; and
provide the vector representation as an output.

15. The apparatus of claim 14, wherein the network is a road network, and wherein the plurality of features is a plurality of road segments in the road network.

16. The apparatus of claim 14, wherein the apparatus is further caused to:
determine a path that passes each edge of the graph representation exactly once,
wherein the linear order is based on the path.

17. The apparatus of claim 14, wherein the apparatus is further caused to:
determine the feature correlation based on a designated property of the plurality of features.

18. A non-transitory computer-readable storage medium carrying one or more sequences of one or more instructions which, when executed by one or more processors, cause an apparatus to perform:
receiving a graph representation of a network of a plurality of features, wherein a plurality of vertices of the graph representation, an edge connecting two vertices of the plurality of vertices, or a combination thereof respectively represents the plurality of features;
determining a linear order of the plurality of features using a trained machine learning model;
generating a vector representation of the plurality of features based on the linear order; and
providing the vector representation as output.

19. The non-transitory computer-readable storage medium of claim 18, wherein the trained machine learning model learns a permutation matrix to reorder an input vector to the linear order during a training phase.

20. The non-transitory computer-readable storage medium of claim 19, wherein the apparatus is caused to further perform:
extracting the permutation matrix from a trained machine learning model; and
implementing the extracted permutation matrix in another machine learning model.
